(19) United States
(12) Patent Application Publication
(10) Pub. No.: US 2021/0354524 A1
(43) Pub. Date: Nov. 18, 2021

(54) SUSPENSION CONTROL DEVICE AND ELECTRORHEOLOGICAL DAMPER

(71) Applicant: Hitachi Astemo, Ltd., Ibaraki (JP)

(72) Inventors: Hiroshi OOKA, Chiba-shi, Chiba (JP); Tatsuro NAMBU, Yokohama-shi, Kanagawa (JP)

(21) Appl. No.: 17/277,432

(22) PCT Filed: Sep. 10, 2019
(86) PCT No.: PCT/JP2019/035435

§ 371 Date: Mar. 18, 2021

(30) Foreign Application Priority Data
Sep. 25, 2018 (JP) 2018-179178

(51) Int. Cl. B60G 17/08; B60G 13/12; B60G 17/015; F16F 9/53

(52) U.S. Cl. CPC B60G 17/08; B60G 2800/162; B60G 17/015; F16F 9/532; B60G 2202/25; F16F 2222/12; F16F 2224/043; F16F 2228/066; F16F 2232/08; B60G 2202/24; B60G 2204/62; B60G 2206/41; B60G 2500/104; B60G 2600/73; B60G 13/12

(57) ABSTRACT

A suspension control device including an electrorheological damper, a high voltage output circuit, a connection portion, and a control unit. The electrorheological damper includes a cylinder sealingly containing electrorheological fluid, a piston, a piston rod, and a positive electrode provided in a portion through which a flow of the electrorheological fluid is generated by a slide of the piston in the cylinder, and configured to apply a voltage to the electrorheological fluid. The connection portion includes an electrode connection portion configured to connect the high voltage output circuit and the positive electrode to each other, and a ground connection portion configured to connect the cylinder and a ground to each other. A resistor member, which has a resistance value set to a load resistance value of the electrorheological fluid in a regular-use temperature range of the electrorheological damper, is provided between the electrode connection portion and the ground connection portion.

### TECHNICAL FIELD

The present invention relates to a suspension control device and an electrorheological damper.

### BACKGROUND ART

In general, in a vehicle, for example, a four-wheeled vehicle, a shock absorber being a cylinder device is provided between each wheel and a vehicle body, and absorbs vibration of the vehicle. As the shock absorber of this type, there has been known an electrorheological damper which sealingly contains electrorheological fluid in a flow passage included in the cylinder device, and is configured to control, through use of an applied voltage, a degree of viscosity of the electrorheological fluid passing through the flow passage, to thereby control a generated damping force. For example, in Patent Literature 1, it is described that a damping force characteristic changes as the temperature of the electrorheological fluid changes.

### CITATION LIST

### Patent Literature

WO 2017/002620 A1

### SUMMARY OF INVENTION

### Technical Problem

In the suspension control device including the electrorheological dampers, a load characteristic of a high voltage circuit configured to apply the voltage to the electrorheological fluid greatly changes in accordance with the temperature characteristic of the electrorheological fluid. It is thus difficult to design a threshold value for failure detection through use of a current value in the circuit.

### Solution to Problem

The present invention has an object to provide a suspension control device and an electrorheological damper which are capable of stably detecting failure independently of temperature of an electrorheological fluid.

According to one embodiment of the present invention, there is provided a suspension control device including: an electrorheological damper which sealingly contains electrorheological fluid having a characteristic to be changed by an electric field, and is configured to adjust a damping force through application of a voltage; a voltage generation unit configured to generate the voltage to be applied to the electrorheological damper; a connection portion configured to connect the voltage generation unit and the electrorheological damper to each other; and a controller configured to control the voltage generation unit, wherein the electrorheological damper includes: a cylinder which sealingly contains the electrorheological fluid; a piston which is inserted into the cylinder so as to be slidable; a piston rod which is coupled to the piston, and extends to an outside of the cylinder; and an electrode which is provided in a portion through which a flow of the electrorheological fluid is generated by the slide of the piston in the cylinder, and is configured to apply a voltage to the electrorheological fluid, wherein the connection portion includes: an electrode connection portion configured to connect the voltage generation unit and the electrode to each other; and a ground connection portion configured to connect the cylinder and a ground to each other, and wherein the electrode connection portion and the ground connection portion has provided therebetween a resistor member which has a resistance value set to a load resistance value of the electrorheological fluid of the electrorheological damper.

According to one embodiment of the present invention, in the suspension control device including the electrorheological dampers, a stable failure detection can be performed independently of the temperature of the electrorheological fluid.

### BRIEF DESCRIPTION OF DRAWINGS

FIG. 1 is a block diagram for illustrating a main portion of a suspension control device according to a first embodiment of the present invention.

FIG. 2 is a cross-sectional view for schematically illustrating a main portion of an electrorheological damper of the suspension control device according to the first embodiment of the present invention.

FIG. 3 is an enlarged cross-sectional view for schematically illustrating a vicinity of the electrorheological damper and a second high voltage connector of a connection portion in the suspension control device according to the first embodiment of the present invention.

FIG. 4 is a graph for showing temperature characteristics of an electric resistance of the electrorheological fluid, a resistor member, and a combined resistance of the electric resistance of the electrorheological fluid and the resistor member in the suspension control device according to the first embodiment of the present invention.

FIG. 5 is a graph for showing a temperature characteristic of an output current of a high voltage output circuit in the suspension control device according to the first embodiment of the present invention.

FIG. 6 is an enlarged cross-sectional view for schematically illustrating a vicinity of an electrorheological damper and a second high voltage connector of a connection portion in a suspension control device according to a second embodiment of the present invention.

### DESCRIPTION OF EMBODIMENTS

Description is now given of embodiments of the present invention with reference to the attached drawings.

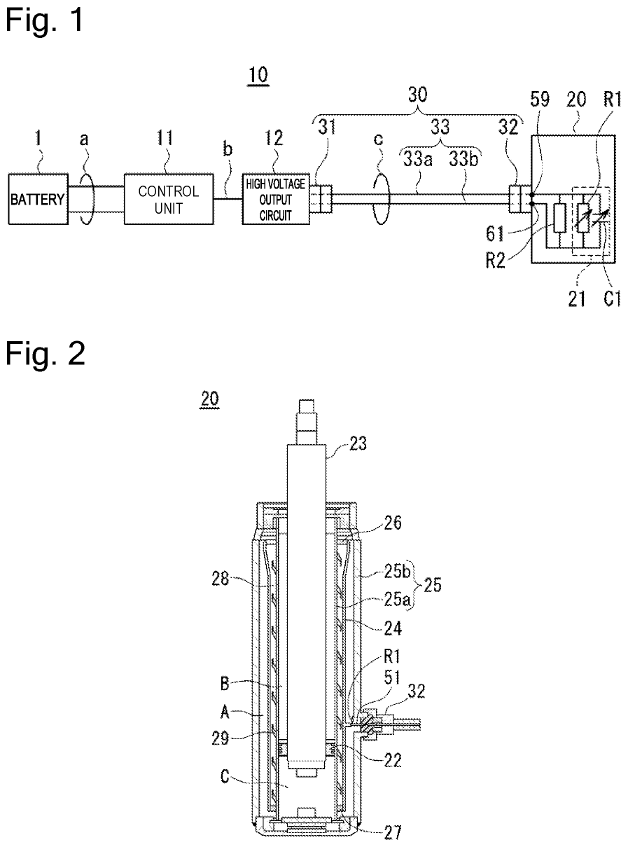

FIG. 1 is a block diagram for illustrating a main portion of a suspension control device 10 according to a first embodiment of the present invention. FIG. 2 is a cross-sectional view for illustrating a main portion of an electrorheological damper 20 of the suspension control device 10 of FIG. 1. As illustrated in FIG. 1, the suspension control device 10 includes a control unit 11, a high voltage output circuit 12, and the electrorheological damper 20. The electrorheological damper 20 is a shock absorber sealingly containing an electrorheological fluid 21 having characteristics (in particular, a degree of viscosity) to be changed in accordance with an electric field, and is configured to adjust its damping force through application of a voltage to the electrorheological fluid 21.

The electrorheological fluid 21 is, for example, particle-dispersed-type electrorheological fluid. The particle-dispersed-type electrorheological fluid includes, for example, base oil formed of silicon oil and the like, and particulates dispersed in the base oil. When an electric field is applied, the particulates are arranged in a direction of the electric field, and viscosity (degree of viscosity) of fluid thus changes in accordance with the electric field. In FIG. 1, in order to clearly illustrate main features of the present invention, the electrorheological fluid 21 is represented by an equivalent circuit indicating electrical characteristics thereof. The electrorheological fluid 21 serving as the equivalent circuit specifically forms a parallel circuit of an electric resistance R1 and an electric capacitor C1. The resistance value and the capacitance value (as required, hereinafter denoted by R1 and C1, respectively, which are the same as the reference symbols of the electric resistance and the electric capacitor) of the electric resistance R1 and the electric capacitor C1 change in accordance with the temperature as described below.

The high voltage output circuit 12 is a voltage generation unit configured to generate an output voltage “c” to be applied to the electrorheological damper 20. The control unit 11 is a controller configured to control the high voltage output circuit 12. Further, the suspension control device 10 includes a connection portion 30 configured to connect the high voltage output circuit 12 and the electrorheological damper 20 to each other. The connection portion 30 is formed of a first high voltage connector 31 on the high voltage output circuit 12 side, a second high voltage connector 32 on the electrorheological damper 20 side, and a high voltage cable 33 configured to connect therebetween. The high voltage cable 33 includes a high voltage output line 33a and a ground line 33b.

A battery 1 is connected to the control unit 11. A power supply voltage “a” is supplied from the battery 1. In this embodiment, the battery 1 is typically a 12 V in-vehicle battery. In this embodiment, the battery 1 is also connected to the high voltage output circuit 12 through intermediation of the control unit 11 or directly (not shown). The high voltage output circuit 12 includes a booster circuit configured to boost the input power supply voltage “a”, and to apply the output voltage “c” obtained through boosting to the electrorheological damper 20 (and, eventually, the electrorheological fluid 21) through intermediation of the connection portion 30. Moreover, the control unit 11 outputs a control signal “b” to the high voltage output circuit 12. The control signal “b” is a high voltage command signal calculated based on vehicle information such as vehicle behaviors or sensors attached to the vehicle. A voltage specified by the command signal corresponds to a damping force to be output in the electrorheological damper 20. The high voltage output circuit 12 generates and outputs the appropriate output voltage “c” in accordance with the control signal “b” output from the control unit 11.

In the suspension control device 10, the control unit 11 may include the high voltage output circuit 12.

Further, the high voltage output circuit 12 includes a failure detection unit (not shown) configured to detect occurrence, in the connection portion 30, of abnormalities (for example, a disconnection of the high voltage cable 33 and detachment and falling-off of the first high voltage connector 31 and/or the second high voltage connector 32). The failure detection unit is configured to detect an output current of the high voltage output circuit 12 (that is, a current flowing through the high voltage cable 33), and to determine that an abnormality has occurred in the connection portion 30 when the detected current is smaller than a predetermined threshold value. The failure detection unit includes any appropriate current detection circuit in order to achieve the above-mentioned function.

As illustrated in FIG. 2, the electrorheological damper 20 includes a cylinder 25, a piston 22, a piston rod 23, and a positive electrode 24. The piston 22 is inserted into the cylinder 25 so as to be slidable. The piston rod 23 is coupled to the piston 22, and extends to the outside of the cylinder 25. In this embodiment, the cylinder 25 includes an inner tube 25a and an outer tube 25b. The inner tube 25a extends in an axial direction. The outer tube 25b is arranged outside the inner tube 25a, and similarly extends in the axial direction. The outer tube 25b constitutes an outer shell of the electrorheological damper 20. The piston 22 is arranged inside the inner tube 25a. The inner tube 25a and the outer tube 25b are formed of a conductive material, and are electrically connected to each other.

The positive electrode 24 is formed into a cylindrical body made of a conductive material, and is arranged coaxially with the inner tube 25a and the outer tube 25b between the inner tube 25a and the outer tube 25b. In particular, the positive electrode 24 forms predetermined spaces in a gap to the inner tube 25a and a gap to the outer tube 25b, respectively, and is arranged so as to be electrically insulated from the inner tube 25a and the outer tube 25b. The space between the positive electrode 24 and the inner tube 25a is hereinafter also referred to as “inter-electrode passage 28.” The space between the positive electrode 24 and the outer tube 25b is also referred to as “reservoir chamber A.” The positive electrode 24 is arranged so as to be fixed to the inner tube 25a by an upper isolator 26 on one end side and a lower isolator 27 on another end side while the inter-electrode passage 28 is secured and the electrical insulation from the inner tube 25a is maintained. The upper isolator 26 and the lower isolator 27 are each made of an insulating material. Further, the electrorheological damper 20 may include a plurality of spacers 29 each made of an insulating material in the inter-electrode passage 28 in order to reliably maintain the inter-electrode passage 28 across an extension thereof in the axial direction.

In the above-mentioned electrorheological damper 20, the electrorheological fluid 21 (not shown in FIG. 2) is sealingly contained in the cylinder 25. In detail, at least a part of the electrorheological fluid 21 is sealingly contained in an upper oil chamber B on the one end side (the upper isolator 26 side) of the inside of the inner tube 25a separated by the piston 22 and a lower oil chamber C on the another end side (the lower isolator 27 side). Further, oil passages (not shown) for allowing the upper oil chamber B and the inter-electrode passage 28 to communicate to/from each other are formed in the inner tube 25a on the one end side (upper isolator 26 side). Oil passages (not shown) for allowing the inter-electrode passage 28 and the reservoir chamber A to communicate to/from each other are formed in the lower isolator 27. The electrorheological damper 20 is configured such that at least a part of the electrorheological fluid 21 in the upper oil chamber B can flow from the oil passages for allowing the upper oil chamber B and the inter-electrode passage 28 to communicate to/from each other into the inter-electrode passage 28, can flow from the one end side (upper isolator 26 side) to the another end side (lower isolator 27 side) in the inter-electrode passage 28, and then can flow out from the oil passages for allowing the lower isolator 27 and the reservoir chamber A to communicate to/from each other into the reservoir chamber A. The notations “upper” and “lower” are used for the convenience of description. The present invention is not limited by the functions (for example, “upper side” and “lower side” in a mounting state) indicated by those notations.

It is preferred that the electrorheological damper 20 according to this embodiment include a so-called uniflow structure, and be configured so as to generate the above-mentioned flow of the electrorheological fluid 21 from the upper oil chamber B to the reservoir chamber A when the piston rod 23 moves forward and backward in the inner tube 25a (that is, in any of a contraction stroke and an extension stroke). Thus, at least a part of the electrorheological fluid 21 sealingly contained in the cylinder 25 exists in the inter-electrode passage 28 and the reservoir chamber A. Simultaneously, as a result of the above-mentioned flow of the electrorheological fluid 21, a flow from the one end side (upper isolator 26 side) to the another end side (lower isolator 27 side) is generated in the inter-electrode passage 28. In this respect, the positive electrode 24 is provided in a portion through which the flow of the electrorheological fluid 21 is generated by the forward and backward movement of the piston 23 in the inner tube 25a (that is, the slide of the piston 22 in the cylinder 25).

Moreover, in the suspension control device 10, the connection portion 30 includes an electrode connection portion 59 and a ground connection portion 61 (not shown in FIG. 2). The electrode connection portion 59 connects the high voltage output circuit 12 and the positive electrode 24 to each other. The ground connection portion 61 connects the cylinder 25 and a ground to each other. The ground refers to a ground electric potential of the high voltage output circuit 12, and, eventually, of the suspension control device 10 being an electric circuit system.

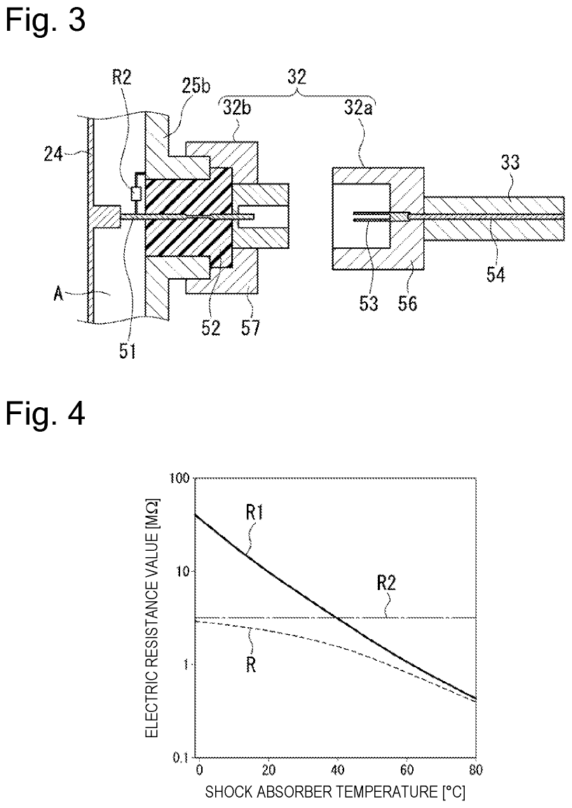

With reference to FIG. 3, description is now given of a mode of the electrode connection portion 59 and the ground connection portion 61. FIG. 3 is an enlarged cross-sectional view for illustrating a vicinity of the electrorheological damper 20 and the second high voltage connector 32 of the connection portion 30. The second high voltage connector 32 includes a member (hereinafter also referred to as “socket”) 32a fixed to the high voltage cable 33 and a member (hereinafter also referred to as “plug”) 32b fixed to the electrorheological damper 20. In FIG. 3, for the convenience of description, there is illustrated a state in which those member 32a and 32b are apart from each other. The notations “plug” and “socket” are used for the convenience of description. The present invention is not limited by the functions (for example, “insertion side” and “reception side”) indicated by those notations.

The socket 32a of the second high voltage connector 32 includes a body 56 made of an insulating material and a connection terminal 53 embedded into the body 56. One end of the connection terminal 53 is connected to a conductor 54 included in the high voltage output line 33a of the high voltage cable 33. Moreover, the plug 32b includes a body 57, a fixing member 52, and a connection terminal 51. The body 57 is formed of an insulating material. The fixing member 52 is similarly formed of an insulating material, and is configured to fix the plug 32b to the outer tube 25b of the electrorheological damper 20. The connection terminal 51 is embedded into the body 57 and the fixing member 52. The connection terminal 51 is configured such that one end side thereof extends into the outer tube 25b of the electrorheological damper 20. The one end is connected to the positive electrode 24.

The pair of electrode terminals 51 and 53 of the second high voltage connector 32 are mechanically and electrically connected to each other by fitting the plug 32b and the socket 32a to each other. As a result, the positive electrode 24 of the electrorheological damper 20 is connected to the high voltage output circuit 12 through intermediation of the high voltage output line 33a. In this embodiment, as described above, the electrode connection portion 59 is achieved as the connection terminal 51 connected to the positive electrode 24 of the second high voltage connector 32.

It is preferred that the ground connection portion 61 be also achieved as a connection terminal of the plug 32b of the second high voltage connector 32, and one end of this connection terminal be connected to the cylinder 25, for example, the outer tube 25b of the electrorheological damper 20 (not shown). Accordingly, the socket 32a includes a connection terminal (not shown) having one end connected to a conductor (not shown) included in the ground line 33b of the high voltage cable 33. In the second high voltage connector 32, when the plug 32b and the socket 32a are fitted to each other, the pair of electrode terminals are also mechanically and electrically connected to each other. As a result, the cylinder 25 (the outer tube 25b and the inner tube 25a) of the electrorheological damper 20 is connected to the ground of the high voltage output circuit 12 through intermediation of the ground line 33b.

With the above-mentioned configuration, the output voltage “c” output from the high voltage output circuit 12 is applied to the electrorheological damper 20 (thus, the electrorheological fluid 21 sealingly contained in the cylinder 25) as the voltage of the positive electrode 24 directed to the cylinder 25. In particular, the voltage of the positive electrode 24 directed to the inner tube 25a (in this case, functioning as a ground electrode) is applied to the electrorheological fluid 21 contained in the inter-electrode passage 28, and the viscosity of the electrorheological fluid 21 at the time when the electrorheological fluid 21 flows through the inter-electrode passage 28 thus changes. The damping force generated by the viscosity of the electrorheological fluid 21 is consequently adjusted in accordance with the applied voltage. Under this state, the electrorheological fluid 21 is an external load of the high voltage output circuit 12 in the sense of electricity, and the resistance value R1 of the electric resistance R1 thereof corresponds to a load resistance value.

Further, in the suspension control device 10, a resistor member R2 is provided between the electrode connection portion 59 and the ground connection portion 61 (in the sense of a connection mode as the electric circuit). Thus, the resistor member R2 and the electric resistance R1 of the electrorheological fluid 21 are electrically connected in parallel (see FIG. 1). The resistor member R2 may be a resistor that is a general electronic component. The present invention is not limited by a spatial arrangement mode of the resistor member R2, but the resistor member R2 is arranged in the reservoir chamber A (that is, the space between the outer tube 25b and the positive electrode 24) of the electrorheological damper 20 in this embodiment. In this arrangement, one end of the resistor member R2 is connected to a portion of the electrode connection portion (connection terminal of the plug 32b) 59 extending into the reservoir chamber A. Another end thereof is connected to the outer tube 25b from the inside thereof.

A resistance value (as required, denoted by R2 which is the same as the reference symbol of the resistor member) of the resistor member R2 is set to a load resistance value of the electrorheological fluid 21 in a regular-use temperature range of the electrorheological damper 20.

In the electrorheological damper 20 according to this embodiment, as described above, the resistor member R2 is arranged in the reservoir chamber A of the electrorheological damper 20, and it is thus preferred that the resistor member R2 and respective contact points of the resistor member R2 to the electrode connection portion 59 and the outer tube 25b have resistance against the electrorheological fluid 21. For example, solvent resistant treatment, for example, coating, may be applied to the resistor member R2 and the contact points.

Description is now given of actions and effects of the suspension control device 10 and the electrorheological damper 20 configured as described above. The electrorheological fluid 21 is represented by the parallel circuit of the electric resistance R1 and the electric capacitor C1 as illustrated in FIG. 1, but, in the present invention, a temperature characteristic of the electric capacitor C1 does not affect the main features of the present invention, and description thereof is therefore omitted.

First, in the electrorheological damper 20, the resistor member R2 is connected in parallel to the electric resistance R1 being the load resistance of the electrorheological damper 20. Thus, an overall load resistance value of the high voltage output circuit 12 is a combined resistance R of the resistance value R1 of the electric resistance R1 and the resistance value R2 of the resistor member R2, and is given by the following expression.

R=R1×R2/(R1+R2) (1)

With reference to FIG. 4, description is now given of temperature characteristics of the electric resistance R1, the resistor member R2, and the combined resistance R. In the graph of FIG. 4, the horizontal axis represents a shock absorber temperature (that is, the temperature of the electrorheological damper 20). As an example of the regular-use temperature range of the electrorheological damper 20 of FIG. 4, a range of from 0° C. to 80° C. is assumed, but the range is not limited to this example. For example, the external air temperature may become a subzero temperature in a cold district. In this case, when the vehicle is parked, or has just started traveling, it is considered that the temperature of the electrorheological fluid 21 is equal to the external air temperature, and thus has a minus value. Meanwhile, the electrorheological damper 20 generates the damping force as the vehicle travels. Kinetic energy is added to the electrorheological fluid 21 through a process of the generation of the damping force. After that, the electrorheological fluid 21 is heated by the added kinetic energy during so-called normal travel, and the shock absorber temperature of the electrorheological damper 20 transitions toward, and consequently becomes the temperature of the electrorheological fluid 21 sealingly contained in the electrorheological damper 20. Further, the temperature of the electrorheological fluid 21 exceeds that of the electrorheological damper 20 due to the addition of the kinetic energy to the electrorheological damper 20.

In other words, a lower limit value of the temperature range of the electrorheological damper 20 depends on the external air temperature at the start of the travel and the like. The temperature of the electrorheological damper 20 and the temperature of the electrorheological fluid 21 are equal to each other during travel on a paved road. The temperature of electrorheological fluid 21 is higher than the temperature of the electrorheological damper 20 on a rough terrain or travel on successive curves. The regular-use temperature range of the electrorheological damper 20 indicates the state in which the temperature of the electrorheological damper 20 and the temperature of electrorheological fluid 21 are equal to each other, or the temperature of electrorheological fluid 21 is higher than the temperature of the electrorheological damper 20.

As shown in FIG. 4, the electric resistance R1 of the electrorheological fluid 21 sharply responds to the temperature, and the resistance value R1 thereof has such a characteristic as to increase as the temperature decreases (the resistance value R1 that changes depending on the temperature T is hereinafter also denoted by R1(T)). In other words, when the regular-use temperature range of the electrorheological fluid 21 is divided into a first temperature region and a second temperature region in which the temperature of electrorheological fluid 21 is higher than that in the first temperature region, the resistance value R1 of the electric resistance R1 of the electrorheological fluid 21 in the second temperature region is lower than that in the first temperature region. In the example of FIG. 4, the electric resistance R1 takes a maximum value R1 max=R1(0° C.) at a temperature of 0° C., and takes a minimum value R1 min=R1(80° C.) at a temperature of 80° C.

Meanwhile, the resistor member R2 is formed of a resistor, which is a general electronic component. The resistance value R2 thereof is substantially constant at least in the regular-use temperature range of the electrorheological damper 20. Further, as described above, the resistance value R2 is set to the load resistance value of the electrorheological fluid 21 in the regular-use temperature range, and, in other words, set as given below.

R1 min=R1(80° C.)<R2<R1 max=R1(0° C.) (2)

In this case, the resistance value R1(T) of the electric resistance R1 is equal to the resistance value R2 of the resistor member R2 at a specific temperature (40° C. in the example of FIG. 4). In particular, when, of the temperature range of the electrorheological fluid 21, a range lower than the temperature at which “R1(T)=R2” is satisfied is referred to as “first temperature region” and a range higher than the temperature at which “R1(T)=R2” is satisfied is referred to as “second temperature region,” the behavior of the combined resistance R with respect to the temperature change can be described as below. In the following description, the combined resistance R that changes depending on the temperature is also denoted by “R(T)” as with “R1(T).” ⋅In the first temperature region, “R1(T)>R2>R(T)” is satisfied, and the graph of the combined resistance R(T) forms a curve having a constant straight line R2 as an asymptote. That is, the combined resistance R approaches the resistance value R2 as the temperature decreases, but does not reach the resistance value R2. ⋅At the temperature at which “R1(T)=R2” is satisfied, “R(T)=R1(T)/2=R2/2” is satisfied. ⋅In the second temperature region, “R2>R1(T)>R(T)” is satisfied, and the graph of the combined resistance R(T) forms a curve having the curve R1(T) as an asymptote. That is, the combined resistance R approaches the resistance value R1 as the temperature increases, but does not reach the resistance value R1.

As can be understood from the above description, in the suspension control device 10 according to this embodiment, even in consideration of the first temperature region in which the temperature of the electrorheological fluid 21 is low and the resistance value R1 of the electric resistance R1 thereof thus significantly increases, a relationship of “I>V/R2 . . . (3)” can be secured, where I represents the output current corresponding to the output voltage V of the high voltage output circuit 12.

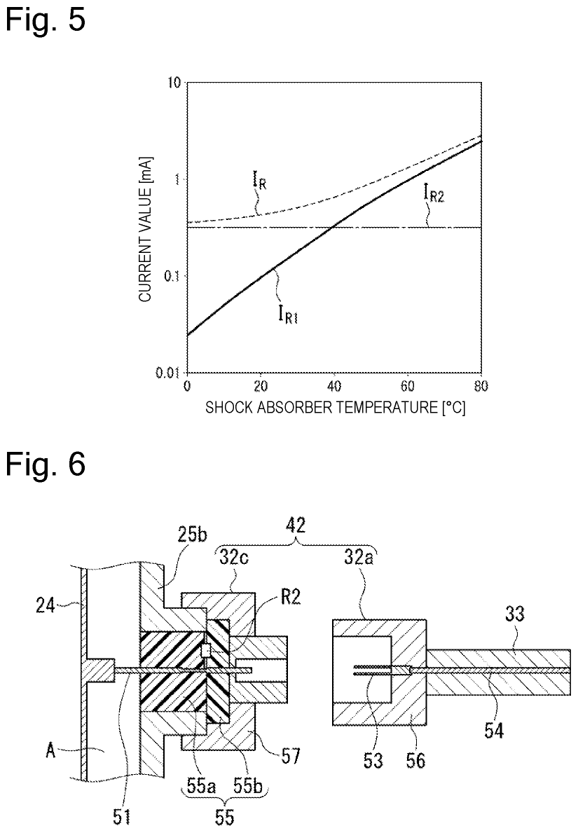

This fact is clearly shown in a graph of FIG. 5. FIG. 5 is a graph for showing a temperature characteristic of the output current I of the high voltage output circuit 12. In FIG. 5, IR1 indicates an output current (IR1=V/R1) at the time when the load of the high voltage output circuit 12 is only the electric resistance R1 of the electrorheological fluid 21. The symbol IR2 indicates an output current (IR2=V/R2) at the time when the load of the high voltage output circuit 12 is only the resistor member R2. The symbol IR indicates an output current (IR=V/R) at the time when the load of the high voltage output circuit 12 is the combined resistance R (that is, in the suspension control device 10 according to this embodiment). As shown in FIG. 5, for the output current IR, a relationship of “IR>IR2” (=V/R2) is maintained even in consideration of the first temperature region in which the temperature of the electrorheological fluid 21 is low and the resistance value R1 of the electric resistance R1 thereof thus significantly increases.

Thus, it is possible to reliably detect occurrence of an abnormality (for example, the disconnection of the high voltage cable 33 and the detachment and the falling-off of the first high voltage connector 31 and/or the second high voltage connector 32) in the connection portion 30 by setting a threshold value for the detected current used for the failure detection to an appropriate value, for example, equal to or smaller than IR2=V/R2. That is, as shown in FIG. 5, the output current (IR=V/R) flowing through the combined resistance R does not fall below the threshold value for the detected current used for the failure detection regardless of the temperature of the electrorheological fluid 21 under a state in which a predetermined voltage is applied. When there occurs an abnormality in which the output current falls below the threshold value for the detected current, it is determined that an abnormality has occurred in the connection portion 30.

The threshold value of the detected current is only required to be equal to or smaller than IR2 (=V/R2). The threshold value for the detected current may be set to IR2 (=V/R2), but it is preferred to set the threshold value to a value in a vicinity thereof in consideration of a case in which an error is included in the detection result.

In a related-art suspension control device, the detection of the failure caused by the detachment and the falling-off of the connector is executed mostly by providing, in parallel to a signal line for a signal to be transmitted or for electric power, as an independent signal line, a signal line used to detect the detachment and the falling-off of the connector. Moreover, as a method of detecting power interruption (disconnection or open circuit) in an electric circuit, there has been well known a method of detecting interruption of signal indicating a value of a current flowing through the electric circuit.

However, in the shock absorber using the electrorheological fluid (electrorheological damper), the electrorheological fluid presents the large characteristic change in accordance with the temperature, and has the significant high resistance particularly at low temperature. In the method of detecting the signal interruption of the current flowing through the electric circuit, the current value to be detected for the failure detection is minute, and it is thus difficult to set a practical threshold value for the current detection, to thereby precisely detect the current. Moreover, in the method of providing, as the independent signal line, the signal line for detecting the detachment and the falling-off of the connector, when only the original power signal line is interrupted by a cause (for example, tensile stress or bending stress) other than the detachment and the falling-off of the connector, it is impossible to detect the interruption of the signal.

Meanwhile, the suspension control device 10 according to this embodiment includes the electrorheological damper 20 which sealingly contains the electrorheological fluid 21 having the characteristic to be changed by the electric field, and is configured to adjust the damping force through the application of the voltage, the high voltage output circuit (voltage generation unit) 12 configured to generate the voltage to be applied to the electrorheological damper 20, the connection portion 30 configured to connect the high voltage output circuit (voltage generation unit) 12 and the electrorheological damper 20 to each other, and the control unit (controller) 11 configured to control the high voltage output circuit (voltage generation unit) 12. Further, the electrorheological damper 20 includes the cylinder 25 which sealingly contains the electrorheological fluid 21, the piston 22 which is inserted into the cylinder 25 so as to be slidable, the piston rod 23 which is coupled to the piston 22, and extends to the outside of the cylinder 25, and the positive electrode (electrode) 24 which is provided in the portion through which the flow of the electrorheological fluid 21 is generated by the slide of the piston 22 in the cylinder 25, and is configured to apply the voltage to the electrorheological fluid 21. The connection portion 30 includes the electrode connection portion 59 configured to connect the high voltage output circuit (voltage generation unit) 12 and the positive electrode (electrode) 24 to each other, and the ground connection portion 61 configured to connect the cylinder 25 and the ground to each other. The suspension control device 10 includes the resistor member R2 which has the resistance value set to the load resistance value of the electrorheological fluid 21 in the regular-use temperature range of the electrorheological damper 20 between the electrode connection portion 59 and the ground connection portion 61.

With the above-mentioned configuration, the suspension control device 10 according to this embodiment can secure the stable detected current value independently of the temperature state of the load of the high voltage output circuit 12. Eventually, it is possible to easily set, in the practical range of the current value, the threshold value for discriminating the current values of the connection portion 30 at the normal time and at the time of occurrence of the abnormality from each other. The failure detection for the connection portion 30 (specifically, detection of the detachment and the falling-off of the first high voltage connector (first connection portion) 31 and/or the second high voltage connector (second connection portion) 32, and/or the disconnection of the high voltage cable (electric wire) 33, and the like) can easily and highly precisely be executed based on the output current of the high voltage output circuit 12.

Moreover, in the suspension control device 10 according to this embodiment, it is not required to independently provide, in parallel to the high voltage output cable (electric wire) 33, a signal line configured to detect the detachment and the falling-off of the first high voltage connector (first connection portion) 31 and/or the second high voltage connector (second connection portion) 32. As a result, the configuration can be simplified, and the weight of the device can be reduced.

In the suspension control device 10 according to this embodiment, the appropriate resistance value R2 of the resistor member R2 and, eventually, the combined resistance value R can be designed without changing a maximum output design of the high voltage output circuit 12, and in consideration of a consumed current of the high voltage output circuit 12 and the like.

With reference to FIG. 6, description is now given of a suspension control device according to a second embodiment of the present invention, mainly focusing on differences from the first embodiment. Portions common to or corresponding to those in the first embodiment are denoted by the same name and the same reference numerals and symbols.

As illustrated in FIG. 6, the suspension control device according to this embodiment is different from the suspension control device 10 according to the first embodiment only in the arrangement mode of the resistor member R2 and the configuration of a second high voltage connector 42.

A configuration of a plug 32c of the second high voltage connector 42 in this embodiment is different from the plug 32b of the second high voltage connector 32 in the first embodiment in the following points. That is, in the plug 32c, a fixing member 55 thereof is formed through a combination of two individual members of a first fixing member 55a and a second fixing member 55b. Moreover, the resistor member R2 is arranged on an interface between the first fixing member 55a and the second fixing member 55b. In this configuration, the contact point between the resistor member R2 and the electrode connection unit 59 and the contact point between the resistor member R2 and the outer tube 25b also exist on an interface between the fixing member 55 of the second high voltage connector 42 and the electrode connection portion 59 and on an interface between the fixing member 55 of the second high voltage connector 42 and the outer tube 25b, respectively.

Moreover, in the suspension control device according to this embodiment, it is preferred that the insulating materials (the upper isolator 26, the lower isolator 27, the spacer 29, and the bodies 56 and 57 and the fixing member 55 of the second high voltage connector 42) provided in the electrorheological damper 20 be selected so that a combined resistance value of the materials is the desired resistance value.

With the above-mentioned configuration, the suspension control device according to this embodiment provides the same actions and effects as those of the suspension control device 10 according to the first embodiment. Moreover, in the suspension control device according to this embodiment, the resistor member R2 is arranged inside the second high voltage connector 42, and the resistor member R2 can thus be arranged without considering solvent resistance.

Note that, the present invention is not limited to the embodiments described above, and includes further various modification examples. For example, in the embodiments described above, the configurations are described in detail in order to clearly describe the present invention, but the present invention is not necessarily limited to an embodiment that includes all the configurations that have been described. Further, a part of the configuration of a given embodiment can replace the configuration of another embodiment, and the configuration of another embodiment can also be added to the configuration of a given embodiment. Further, another configuration can be added to, deleted from, or replace a part of the configuration of each of the embodiments.

The present application claims a priority based on Japanese Patent Application No. 2018-179178 filed on Sep. 25, 2018. All disclosed contents including Specification, Scope of Claims, Drawings, and Abstract of Japanese Patent Application No. 2018-179178 filed on Sep. 25, 2018 are incorporated herein by reference in their entirety.

### REFERENCE SIGNS LIST

10 suspension control device, 11: control unit (controller), 12: high voltage output circuit (voltage generation unit), 20: electrorheological damper, 21: electrorheological fluid, 25: cylinder, 22: piston, 23: piston rod, 24: positive electrode (electrode), 30: connection portion, 59: electrode connection portion, 61: ground connection portion, R2: resistor member

1. A suspension control device, comprising:
an electrorheological damper which sealingly contains electrorheological fluid having a characteristic to be changed by an electric field, and is configured to adjust a damping force through application of a voltage;
a voltage generation unit configured to generate the voltage to be applied to the electrorheological damper;
a connection portion configured to connect the voltage generation unit and the electrorheological damper to each other; and
a controller configured to control the voltage generation unit,
wherein the electrorheological damper includes:
a cylinder which sealingly contains the electrorheological fluid;
a piston which is inserted into the cylinder so as to be slidable;
a piston rod which is coupled to the piston, and extends to an outside of the cylinder; and
an electrode which is provided in a portion through which a flow of the electrorheological fluid is generated by the slide of the piston in the cylinder, and is configured to apply a voltage to the electrorheological fluid,
wherein the connection portion includes:
an electrode connection portion configured to connect the voltage generation unit and a positive electrode of the electrode to each other; and
a ground connection portion configured to connect the cylinder and a ground to each other,
wherein a resistor member is provided between the electrode connection portion and the ground connection portion, the resistor member having a resistance value set to a load resistance value of the electrorheological fluid of the electrorheological damper, and
wherein the resistor member has a resistance value set to a load resistance value in a regular-use temperature range of the electrorheological fluid of the electrorheological damper.

2. (canceled)

3. The suspension control device according to claim 1,
wherein the connection portion includes a first connection portion, a second connection portion, and an electric wire, the first connection portion being provided on the voltage generation unit side, the second connection portion being provided on the electrorheological damper side, the electric wire connecting the first connection portion and the second connection portion to each other, and
wherein the resistor member is provided between the second connection portion and the electrorheological damper.

4. The suspension control device according to claim 1, wherein a resistance value of the electrorheological fluid is lower in a second temperature region than in a first temperature region, the temperature of the electrorheological fluid in the second temperature region being higher than the temperature of the electrorheological fluid in the first temperature region.

5. The suspension control device according to claim 1, wherein a regular-use temperature range of the electrorheological fluid of the electrorheological damper is a range of from 0° C. to 80° C.

6. The suspension control device according to claim 1, further comprising a failure detection unit,
wherein the failure detection unit is configured to detect an output current from the voltage generation unit when a predetermined voltage is applied, and to determine that an abnormality has occurred in the connection portion when the detected output current is smaller than a predetermine threshold value.

7. The suspension control device according to claim 1, wherein the predetermined threshold value is equal to or smaller than a current that flows through the resistor member when the predetermined voltage is applied.

8. An electrorheological damper, which sealingly contains electrorheological fluid having a characteristic to be changed by an electric field, and is configured to adjust a damping force through application of a voltage,
the electrorheological fluid forming a parallel circuit of an electric resistance and an electric capacitor,
the electrorheological damper comprising a resistor member which is provided so as to be connected to the electric resistance in parallel.

9. The suspension control device according to claim 3, wherein a resistance value of the electrorheological fluid is lower in a second temperature region than in a first temperature region, the temperature of the electrorheological fluid in the second temperature region being higher than the temperature of the electrorheological fluid in the first temperature region.

10. The suspension control device according to claim 3, wherein a regular-use temperature range of the electrorheological fluid of the electrorheological damper is a range of from 0° C. to 80° C.

11. The suspension control device according to claim 3, further comprising a failure detection unit,
wherein the failure detection unit is configured to detect an output current from the voltage generation unit when a predetermined voltage is applied, and to determine that an abnormality has occurred in the connection portion when the detected output current is smaller than a predetermine threshold value.

12. The suspension control device according to claim 4, further comprising a failure detection unit,
wherein the failure detection unit is configured to detect an output current from the voltage generation unit when a predetermined voltage is applied, and to determine that an abnormality has occurred in the connection portion when the detected output current is smaller than a predetermine threshold value.

13. The suspension control device according to claim 3, wherein the predetermined threshold value is equal to or smaller than a current that flows through the resistor member when the predetermined voltage is applied.

14. The suspension control device according to claim 4, wherein the predetermined threshold value is equal to or smaller than a current that flows through the resistor member when the predetermined voltage is applied.

15. The suspension control device according to claim 5, wherein the predetermined threshold value is equal to or smaller than a current that flows through the resistor member when the predetermined voltage is applied.
